(19) United States
(12) Patent Application Publication
(10) Pub. No.: US 2014/0272670 A1
(43) Pub. Date: Sep. 18, 2014

(54) METHOD AND APPARATUS FOR MAKING A FUEL STORAGE TANK WITH A LINER AND INNER BAG FOR A FUEL STORAGE SYSTEM

(71) Applicant: GM Global Technology Operations LLC, Detroit, MI (US)

(72) Inventors: Ludger Strack, Heidenrod (DE); Frank Joepen, Aachen (DE); Kolja Richlowski, Aachen (DE)

(73) Assignee: GM Global Technology Operations LLC, Detroit, MI (US)

(21) Appl. No.: 14/202,752

(22) Filed: Mar. 10, 2014

Related U.S. Application Data
(60) Provisional application No. 61/789,589, filed on Mar. 15, 2013.

(51) Int. Cl. H01M 8/04; F17C 13/00

(52) U.S. Cl. CPC H01M 8/04201; F17C 13/00; F17C 2209/22; F17C 2209/232
USPC 429/515; 429/535

(57) ABSTRACT

An apparatus and method of manufacturing a fuel storage tank for a fuel cell system used for storing various pressurized fluids having separate permeation characteristics for reducing permeation leakage during various temperature and pressure cycles. The fuel storage tank comprises a formed liner to define an inner cavity, as well as a boss connected to the liner, a reinforcement structure formed around a portion of the boss and the liner, a permeation bag affixed to a first securing member and inserted into the inner cavity of the liner. The first securing member is coupled with the boss and a second securing member is assembled to the boss adjacent the first securing member to secure a fluid tight connection between the permeation bag, the liner and the boss.

### CROSS REFERENCE TO RELATED APPLICATION

This application claims the benefit of U.S. Provisional Application Ser. No. 61/789,589, filed Mar. 15, 2013.

### FIELD OF THE INVENTION

The present disclosure relates generally to a fuel storage system, and more particularly to a fuel storage tank with a single layer liner having separate permeability characteristics and functions to reduce permeation leakage due to variations in temperature and pressure cycles within the fuel storage tank used for storing pressurized fluids.

### BACKGROUND

A pressure vessel for storing high pressure gaseous mediums (such as hydrogen, compressed natural gas, or air) typically may be multi-layered and include an inner liner and an outer liner, at least one mouthpiece (metal boss), and a filament wound outer shell to support the pressure vessel. The pressure vessel may be incorporated into a vehicle to supply hydrogen to a proton exchange membrane (PEM) fuel cell stack capable of powering the vehicle, for example. Hydrogen stored within the vessel may be pressurized to at least 70 MPa to accommodate a travel range of the vehicle consistent with consumer needs. Accordingly, adequate sealing between the inner liner and the at least one boss is necessary to militate against loss of the gaseous medium.

The inner liner may be produced by any conventional process such as rotational molding, blow molding, injection molding, or thermoforming. As examples, WO 1999/039896; WO 2007/079971; DE 19526154; and WO 1999/013263 disclose pressure vessels including an inner liner, each of which are incorporated herein by reference in their entirety.

The pressure vessel may be multi-layered and include at least an inner liner and an outer liner. The inner liner may be formed from a plurality of components welded together. By using a welding process, the types of materials used to form the inner liner are restricted, and permeation of a stored fluid through weldseams of the welded inner liner may result. In addition, multi-layered liners comprise an interfacial layer that may be injection overmolded over a pinch line formed during the blow molding step of the inner liner of the mold die which may cause problems with permeation leakage.

The gaseous medium passes through the boss when one of entering and exiting the pressure vessel. The boss is typically configured with one of threads or other coupling means to accept a valve, a sensor, a coupler, a conduit, or other device. Accordingly, the boss provides a reliable and versatile coupling point for the pressure vessel.

The boss typically includes a cylindrical neck with a longitudinal passage that provides fluid communication between the pressure vessel and the environment outside the vessel. A longitudinal axis is defined within the neck as substantially parallel to a direction of the passage between open ends thereof. In certain designs, a flange is secured to one end of the neck. The flange, which is larger than the pressure vessel orifice, is secured to the liner of the pressure vessel to militate against relative movement between the boss and the liner.

Sealing elements such as a compression fitting and O-rings may be disposed between the boss and the inner plastic lining to militate against an unintended loss of the gaseous medium. Multi-piece boss designs, a plurality of sealing elements, or compression of the lining by the boss may be used to form a seal between the inner plastic lining and the boss. A multi-piece boss design for a pressure vessel including an inner plastic lining, wherein a seal is disposed between the boss and the lining. In addition to requiring a complicated assembly procedure, the multi-piece boss design does not accommodate fluctuating forces exerted on the seal caused by repeated thermal cycles and pressure cycles.

The pressure vessel may also include a wound outer shell formed with a filament winding process. After the winding process, the wound outer shell is connected to the liner and cured in an autoclave subjecting them to a high pressure temperature load. Currently, the materials used to meet permeation requirements are not suitable for providing a proper outside surface to maximize the performance of a composite winding. Likewise, the materials typically used to produce a smooth outer surface on the vessel liner may not provide suitable permeability for particular fluids stored in the pressure vessel.

Pressure vessels known in the art do not accommodate fluctuating forces exerted on the seal formed between the liner and the boss caused by repeated temperature and pressure cycles. When the pressure vessel is subjected to high pressure and temperature of the fluid within the vessel causes the inner liner to increase in size to an expanded state, increasing a force exerted by the seal on the boss and the liner. Conversely, when the pressure vessel is subjected to low pressure and temperature of the fluid within the vessel causes the inner liner to retract in size from the expanded state, decreasing a force exerted by the seal on the boss and the liner. Such flexible characteristics have been a continuing problem for automotive manufacturers due to permeation leakage through the seals and the formed liners.

While such pressure vessels work well for their intended purpose, the present inventors have determined that there remains a need to develop a pressure vessel and a method of manufacturing the pressure vessel having a design with a single layer liner with varying dimensions, having separate permeability characteristics and functions which are added after the filament winding and curing process of the wound outer shell, liner and boss. Such a need will avoid permeation leakage due to the forces exerted on the seal formed between the liner and the boss; avoid pinch line permeation leakage associated with multi-layered liners due to the various temperature and pressure cycles within the pressure vessel used for storing various pressurized fluids. Such needs will allow manufacturing of the pressure vessel easier, completed in less time and reduced costs.

### SUMMARY

Against the above background, the present disclosure is directed to a fuel storage tank and a method of manufacturing the fuel storage tank for a fuel cell system, wherein the fuel storage tank and method provide a design with a single layer liner with varying dimensions, includes separate permeability characteristics and functions which are added after the filament winding and curing process of the wound outer shell, liner and boss, and avoidance of pinch line permeation leakage associated with a multi-layered liner such that permeation leakage is reduced during various temperature and pressure cycles within the fuel storage tank used for storing various pressurized fluids.

In one embodiment, a method of manufacturing a hydrogen storage tank for a fuel cell system may comprise forming a generally axisymmetric liner to define an inner cavity of the hydrogen storage tank as well as connecting at least one boss to an opening formed in at least one end of the liner and forming a reinforcement structure around at least a portion of the at least one boss and the liner. Affixing a permeation bag to a first securing member, inserting the permeation bag into the inner cavity, coupling the first securing member with the at least one boss, and assembling a second securing member to the at least one boss adjacent the first securing member to secure a connection between the permeation bag, the liner and the at least one boss.

In another embodiment, a method of manufacturing a fuel storage tank for a fuel cell system such that a formed portion of the fuel storage tank may comprise a single layer liner defining an inner cavity, at least one boss formed in an opening of the liner and a reinforcement structure formed around at least a portion of the at least one boss and the liner. The method may comprise affixing a permeation bag to a first securing member, inserting the permeation bag into the inner cavity, coupling the first securing member with the at least one boss, and assembling a second securing member to the at least one boss adjacent the first securing member to secure a connection between the permeation bag and the fuel storage tank.

In yet a further embodiment, a hydrogen storage tank for a fuel cell system may comprise a generally axisymmetric liner formed to define an inner cavity of the hydrogen storage tank, as well as at least one boss connected to an opening formed in at least one end of the liner, and a reinforcement structure formed around at least a portion of the at least one boss and the liner. A permeation bag affixed to a first securing member wherein the permeation bag is inserted into the inner cavity. The first securing member is coupled with the at least one boss and a second securing member is assembled to the at least one boss adjacent the first securing member to secure a connection between the permeation bag, the liner, and the at least one boss.

These and other features, aspects and advantages of the present disclosure will become better understood with reference to the following description and the appended claims.

### BRIEF DESCRIPTION OF THE DRAWINGS

Though the specification concludes with claims particularly pointing out and distinctly claiming the present disclosure, it is believed that the present disclosure will be better understood from the following description taken in conjunction with the accompanying drawings, in which:

FIG. 1A is a partial, perspective view of a boss region within a fuel storage tank according to an aspect of the present disclosure;

FIG. 1B is a partial, cross-sectional view of a boss region within a fuel storage tank according to another aspect of the present disclosure;

FIG. 2 is an exploded partial cross-sectional view of the boss region of the fuel storage tank of FIG. 1A;

FIG. 3A is a cross-sectional view of the fuel storage tank as shown in FIG. 1A prior to pressurizing a permeation bag that is disposed therein with a fluid to be stored; and

FIG. 3B is a cross-sectional view of the fuel storage tank of FIG. 3A with the permeation bag in a pressurized state.

### DETAILED DESCRIPTION

Features and advantages of the disclosure will now be described with occasional reference to specific embodiments. However, the disclosure may be embodied in different forms and should not be construed as limited to the embodiments set forth herein. Rather, these embodiments are provided so that this disclosure will be thorough and complete and will fully convey the scope of the disclosure to those skilled in the art.

The present disclosure provides an apparatus and method for manufacturing a fuel storage tank with varying dimensions to provide a single layer liner with separate permeability characteristics and functions added after the filament winding and curing process, and avoid pinch line permeation leakage associated with multi-layered liners such that temperature and pressure ranges are ensured by reducing permeation leakage within the fuel storage tank used for storing various pressurized fluids. Thus the new design eliminates current problems associated with permeation leakage within the fuel storage tank reducing the loss of the gaseous medium at varying temperature and pressure cycles and allowing the manufacturing of the fuel storage tank to be easier, completed in less time and reduce manufacturability costs.

The pressurized fluid as described in the various embodiments herein may be any fluid such as gas such as hydrogen gas, compressed natural gas, and oxygen gas, a liquid, and both a liquid and a gas, for example.

Referring now to the Figures, FIG. 1A is a partial, perspective view of a boss region 30 within a fuel storage tank 10. Wherein the fuel storage tank 10 is formed as a hollow tank adapted to hold pressurized fluid (not shown) with the following elements described herein.

FIG. 1A illustrates a boss 30 commonly known as a divided boss having a first component 32 and a second component 34. The first component 32 and a second component 34 of the boss 30 are connected to a portion of the liner 20, for example, the neck portion 23 and the shoulder portion 25, by a process known in the art such that the first component 32 is coupled to a blow pin (not shown), known in the art of blow molding. Additionally, a parison (not shown) of the liner 20 is guided around the shoulder portion 36 of the first component 32. As such, a blow tool, known in the art, closes around the parison and “pinches” or secures the parison around a circumference of the neck portion 38 and the shoulder portion 36 of the first component 32. The shoulder portion 36 of the first component 32 includes a protrusion 39; the protrusion 39 engages the liner 20 to minimize radial elongation and movement of the liner 20. Thereafter, the blow pin introduces air into the parison, thereby expanding the parison into the liner 20 to define an inner cavity 22 and an opening 24. After the liner 20 has a desired form, the blow tool releases the liner 20 and any scrap material of the parison is removed by a cutting process known to one skilled in the art of blow molding. Therefore, the single layer liner 20 provides temperature and pressure ranges are ensured within the fuel storage tank 10 by reducing permeation leakage without using the process of welding together a plurality of components or the use of multi-layers that may be injection overmolded over a pinch line formed during the blow molding step. Other processes such as rotational molding, injection molding, or thermoforming may be used to form the liner 20.

As known in the art, the boss 30 comprising a second component 34 engages the first component 32 to secure the liner 20 therebetween. The second component 34 is secured to the first component 32 by screwing the components 32, 34 together through a threaded connection (not shown). In certain embodiments known in the art, a fastener device engages the first component 32 to minimize a rotational motion of the first component 32 while the second component 34 is screwed to the first component 32 (not shown).

The first component 32 and the second component 34 of the boss 30 cooperate to form a substantially fluid-tight seal to the liner 20. The boss 30 may have any size and diameter such as a size and diameter suitable for coupling with fixation cores, threaded sleeves, nozzles, valves, gauges, tubes, a thermal-pressure relief device (TPRD) and similar fixtures which direct and control fluid. In some embodiments, additional sealing elements known in the art may be disposed between the boss 30 and the liner 20 to militate against an unintended loss of the gaseous medium.

A reinforcement structure 40 may be formed around at least a portion of the boss 30 and the liner 20. The reinforcement structure 40 is a wound outer shell formed with a filament winding process, a rotational molding process, and a curing process known in the art. In one form, the reinforcement structure 40 may be formed from one of a carbon fiber, a glass fiber, a composite fiber, and a fiber having a resin coating. It is understood that the material used to form the reinforcement structure 40 may be selected based on the process used to affix the reinforcement structure 40 to the liner 20 and the use of the fuel storage tank 10. It is also understood that the liner 20, the boss 30 and the reinforcement structure 40 may have any shape and size determined by the forming process. The fuel storage tank 10 for a fuel cell system requires a reinforcement structure 40 capable of withstanding high inner pressure from at least about 20 to 70 MPa.

The liner 20 is a single layer liner having a substantially cylindrical axisymmetric shape; however the liner 20 may have any shape, as desired. The liner 20 may be formed from a thermoplastic, such as polyoxymethylene (POM), acrylonitrile butadiene styrene copolymers/polycarbonate (ABS/PC), or polyamide (PA), for example. The liner 20 may also be formed from any moldable material such as a thermoplastic elastomer or a thermosetting plastic, and the like. The liner 20 having at least two functions, to provide a barrier for the pressurized fluid, and to provide a mandrel for the reinforcement structure 40 during the winding process.

A second, separate or split permeation layer comprising a permeation bag 50 is manufactured outside the liner 20, boss 30 and reinforcement structure 40. The permeation bag 50 is affixed by clamping or welding the permeation bag 50 to the bottom surface 53 of the first securing member 52 and coupled inside the material joint coupling surface 58. Once the permeation bag 50 is affixed to the first securing member 52, the permeation bag 50 is inserted into the inner cavity 22 through the opening 24 formed by the liner 20 thus allowing the bottom surface 53 of the first securing member 52 to seat on the top surface clearance 37 of the second component 34 such that the top surface 55 of the first securing member 52 sits below the helical thread or groove formed on inside surface 35 of the second component 34. In this manner, the permeation bag 50 is squeezed, pressed or clinched inside the material joint coupling surface 58 of the first securing member 52 and simultaneously to the top surface clearance 37 of the second component 34. The use of the first securing member 52 eliminates an uneven sealing surface or drapery effect thus avoiding permeation leakage within the fuel storage tank 10. A second securing member 54 having a substantially helical thread or groove formed on an outside surface 56, a bottom surface 57 and a top surface 59 is cooperatively engaged with the substantially helical thread or groove formed on inside surface 35 of the second component 34 such that the bottom surface 57 of the second securing member 54 abuts the top surface 55 of the first securing member 52 to secure a tight or fixed connection with the first securing member 52 having a permeation bag 50 attached thereto and the top surface clearance 37 of the second component 34 of the boss 30, and the second securing member 54 to the second component 34 of the boss 30. The permeation bag 50 is shown in FIG. 1A in an expanded, enlarged state due to the fuel storage tank 10 being subjected to high pressure and temperature of the fluid (not shown) within the fuel storage tank 10, the permeation bag 50 does not adhere to the inner wall 21 of liner 20, the permeation bag 50 expands to shape of inner wall 21 of the liner 20. Alternatively, another embodiment as shown and described below in conjunction with FIG. 3B, the permeation bag 50 may be in a retracted, crimped state laying loosely inside the inner cavity 22 of the liner 20 due to the fuel storage tank 10 being subjected to low pressure and temperature of the fluid (not shown) within the fuel storage tank 10. Similarly, when the fluid inside the fuel storage tank 10 is subjected to high pressure and temperature the liner 20 will increase in size to an expanded state. Conversely, when the fluid inside the fuel storage tank 10 is subjected to low pressure and temperature the liner 20 will retract in size from the expanded state.

The first securing member 52 may comprise a fixation core such as, but not limited to an, O-ring. The second securing member 54 may comprise a sleeve having a substantially helical thread or groove formed on an outside surface 56. The first securing member 52 and second securing member 54 are formed of a plastic or another conventional material having desired properties. The second securing member 54 which may have any size and diameter such as a size and diameter suitable for coupling with nozzles, valves, gauges, tubes, TPRD and similar fixtures which direct and control fluid. The first securing member 52 disables rotary movement of the permeation bag 50 while the second securing member 54 is cooperatively attached to the second component 34.

The permeation bag 50 is manufactured using a continuous foil extrusion flat or tubular film process having an inner layer and an outer layer. In one embodiment, the inner layer of the permeation bag 50 comprises an aluminum composite flat film material having a thickness of at least 0.012 to 0.015 mm and the outer layer of the permeation bag 50 comprises a high density polyethylene such that the thickness of permeation bag 50, inner layer and the outer layer, is at least about 0.1 mm. In a further embodiment, the inner layer of the permeation bag 50 comprises an aluminum coated cyclic olefin copolymer tubular film foil material having a thickness of at least 0.00005 mm and the outer layer of the permeation bag 50 comprises a high density polyethylene or polyethylene such that the thickness of the permeation bag 50, inner layer and outer layer, is between about 0.013 to 0.03 mm. In yet a further embodiment, the inner layer of the permeation bag 50 comprises silicon monoxide coated with polyethylene terephthalate and polyamide flat film foil material having a thickness of at least 0.00004 to 0.00009 mm and an outer layer of the permeation bag 50 comprises a sealable polypropylene or polyethylene terephthalate such that the thickness of the permeation bag 50, the inner and the outer layer, is between about 0.012 to 0.075 mm.

The permeation bag 50, having a separate, second permeation layer is manufactured and inserted after the filament winding and curing process of the reinforcement structure 40, the liner 20 and the boss 30 is to eliminate permeability degradation of permeation bag 50 during high temperature and pressure stresses and to allow manufacturing of the fuel storage tank 10 to be simple, be completed in less time and reduce manufacturability costs.

Due to the permeation bag 50 being subjected to various pressure and temperature cycles, the permeation bag 50 is manufactured to be longer than the liner 20 to ensure cycle durability. For example, the permeation bag 50 may be at least about 900 mm and the liner 20 may be at least about 840 mm. In preferred embodiments, the fuel storage tank 10 is a long thin design, for example, having a length between about 560 mm to 870 mm. Also for comparison to the length of the fuel storage tank 10, the width of the opening 24 and the second component 34 of the boss 30 may be between about 5 to 6 inches and the outer width of the liner 20 may be between about 9 to 10 inches. An advantage to the dimensions of the fuel storage tank 10 is a tolerance of circularity with a larger diameter liner reduces tolerance by a lower demolding temperature and thus resulting in longer acting temperature and pressure cycles. Also, the cross section of the permeation bag 50 depends on the dimension of the liner 20 which has been found to be of particular importance for the assembling process of the first and second securing members 52, 54 onto the boss 30.

In another embodiment (not shown), the permeation bag 50 is affixed by clamping or welding the permeation bag 50 to the bottom surface 53 of the first securing member 52 and coupled inside the material joint coupling surface 58. Another first securing member 52a having a material joint coupling surface 58a, a top surface 55a and bottom surface 53a (not shown) is attached to the first securing member 52 such that the bottom surface 53a of the first securing member 52a may be joined by a welding process to the bottom surface 53 of the first securing member 52 securing the permeation bag 50 inside the material joint coupling surfaces 58, 58a of the first securing members 52, 52a. Once the permeation bag 50 is affixed to the first securing members 52, 52a the permeation bag 50 is inserted into the inner cavity 22 through the opening 24 formed by the liner 20 thus allowing the top surface 55a of the first securing member 52a to abut the top surface clearance 37 of the second component 34 and the top surface 55 of the first securing member 52 sits below the helical thread or groove formed on inside surface 35 of the second component 34. The use of the first securing members 52, 52a eliminates an uneven sealing surface or drapery effect thus avoiding permeation leakage within the fuel storage tank 10. A second securing member 54 having a substantially helical thread or groove formed on an outside surface 56, a bottom surface 57 and a top surface 59 is cooperatively engaged with the substantially helical thread or groove formed on inside surface 35 of the second component 34 such that the bottom surface 57 of the second securing member 54 abuts the top surface 55 of the first securing member 52 to secure a tight or fixed connection with the first securing members 52, 52a having a permeation bag 50 attached thereto and the second securing member 54 to the second component 34 of the boss 30. The permeation bag 50 may be in an expanded, enlarged state due to the fuel storage tank 10 being subjected to high pressure and temperature of the fluid (not shown) within the fuel storage tank 10, the permeation bag 50 does not adhere to the inner wall 21 of liner 20, the permeation bag 50 expands to shape of inner wall 21 of the liner 20. Alternatively, the permeation bag 50 may be in a retracted, crimped state laying loosely inside the inner cavity 22 of the liner 20 due to the fuel storage tank 10 being subjected to low pressure and temperature of the fluid (not shown) within the fuel storage tank 10. Similarly, when the fluid inside the fuel storage tank 10 is subjected to high pressure and temperature the liner 20 will increase in size to an expanded state. Conversely, when the fluid inside the fuel storage tank 10′ is subjected to low pressure and temperature the liner 20 will retract in size from the expanded state.

FIG. 1B shows another embodiment of the disclosure similar to that shown in FIG. 1A. Reference numerals for similar structure in respect of the description of FIG. 1A are repeated in FIG. 1B with a prime (′) symbol.

FIG. 1B is a partial, cross-sectional view of a boss region 30′ within a fuel storage tank 10. FIG. 1B illustrates a boss 30′ having a second component 34′. The second component 34′ of the boss 30′ is connected to the liner 20′ by a process known in the art such that the second component 34′ is coupled to a blow pin (not shown), known in the art of blow molding. Additionally, a parison (not shown) of the liner 20′ is guided around the shoulder portion 31′ of the second component 34′. As such, a blow tool, known in the art, closes around the parison and pinches or secures the parison around a circumference of the neck portion 33′ and the shoulder portion 31′ of the second component 34′. The second component 34′ engages the neck portion 23′ and shoulder portion 25′ of the liner 20′ to minimize radial elongation and movement of the liner 20′. Thereafter, the blow pin introduces air into the parison, thereby expanding the parison into the liner 20′ to define an inner cavity 22′ and an opening 24′. After the liner 20′ has a desired form, the blow tool releases the liner 20′ and any scrap material of the parison is removed by a cutting process known to one skilled in the art of blow molding. Therefore, the use of a single layer liner 20′ ensures that permeation leakage is avoided and the known interfacial layer that may be injection overmolded over a pinch line formed using a multi-layered liner during the blow molding step is eliminated. Other processes such as rotational molding, injection molding, or thermoforming may be used to form the liner 20′. Thus the liner 20′ is formed without any additional layers known in the art.

A section of the neck portion 33′ of the second component 34′ has substantially helical threads or grooves formed on an inside surface 35′. The second component 34′ of the boss 30′ also comprises a top surface clearance 37′ and a bottom surface clearance 37a′ formed substantially thereon and adjacent the top neck surface 23a′ of the liner 20′ which may have any size and diameter such as a size and diameter suitable for coupling with fixation cores, treaded sleeves, nozzles, valves, gauges, tubes, TPRD and similar fixtures which direct and control fluid.

The second component 34′ of the boss 30′ cooperates to form a substantially fluid-tight seal to the liner 20′. Additionally, the boss 30′ having a second component 34′ provides a means for attaching various devices and utility elements to the second component 34′ and the liner 20′.

A second, separate or split permeation layer comprising a permeation bag 50′ is manufactured outside the liner 20′, the boss 30′ having a second component 34′ and the reinforcement structure 40′. The permeation bag 50′ is affixed via clamping or welding to the bottom surface 53′ of the first securing member 52′ and coupled inside the material joint coupling surface 58′. Once the permeation bag 50′ is affixed to the first securing member 52′ the permeation bag 50′ is inserted into the inner cavity 22′ through the opening 24′ of the liner 20′ thus allowing the bottom surface 53′ of the first securing member 52′ to abut the top surface clearance 37′ of the second component 34′ and the top surface 55′ of the first securing member 52′ sits below the helical thread or groove formed on inside surface 35′ of the second component 34′. In this manner, the permeation bag 50′ is squeezed, pressed or clinched inside the material joint coupling surface 58′ of the first securing member 52′ and simultaneously to the top surface clearance 37′ of the second component 34′ and adjacent the top neck surface 23a′ of the liner 20′. The use of the first securing member 52′ eliminates an uneven sealing surface or drapery effect therefore avoiding permeation leakage within the fuel storage tank 10′. A second securing member 54′ having a substantially helical thread or groove formed on an outside surface 56′, a bottom surface 57′ and a top surface 59′ is cooperatively engaged with the substantially helical thread or groove formed on inside surface 35′ of the second component 34′ such that the bottom surface 57′ of the second securing member 54′ abuts the top surface 55′ of the first securing member 52′ to secure a tight or fixed connection with the first securing member 52′ which has the permeation bag 50′ affixed thereto and the second securing member 54′ to the second component 34′ of the boss 30′. The permeation bag 50′ is shown in FIG. 1B in an expanded, enlarged state due to the fuel storage tank 10′ being subjected to high pressure and temperature of the fluid (not shown) within the fuel storage tank 10′, the permeation bag 50′ does not adhere to the inner wall 21′ of liner 20′, the permeation bag 50′ expands to shape of inner wall 21′ of the liner 20′. Alternatively, another embodiment not shown, the permeation bag 50′ may be in a retracted, crimped state laying loosely inside the inner cavity 22′ of the liner 20′ due to the fuel storage tank 10′ being subjected to low pressure and temperature of the fluid (not shown) within the fuel storage tank 10′. Similarly, when the fluid inside the fuel storage tank 10′ is subjected to high pressure and temperature the liner 20′ will increase in size to an expanded state. Conversely, when the fluid inside the fuel storage tank 10′ is subjected to low pressure and temperature the liner 20′ will retract in size from the expanded state.

In another embodiment (not shown), the permeation bag 50′ is affixed by clamping or welding to the bottom surface 53′ of the first securing member 52′ and coupled inside the material joint coupling surface 58′. Another first securing member 52a′ having a material joint coupling surface 58a′, a top surface 55a′ and bottom surface 53a′ (not shown) is attached to the first securing member 52′. Such that the bottom surface 53a′ of the first securing member 52a′may be joined by a welding process to the bottom surface 53′ of the first securing member 52′ securing the permeation bag 50′ inside the material joint coupling surfaces 58′, 58a′ of the first securing members 52′, 52a′. Once the permeation bag 50′ is affixed to the first securing members 52′, 52′ the permeation bag 50′ is inserted into the inner cavity 22′ through the opening 24′ of the liner 20′ thus allowing the top surface 55a′ of the first securing member 52a′ to abut the top surface clearance 37′ of the second component 34′ of the boss 30′, adjacent the top neck surface 23a′ of the liner 20′, such that the top surface 55′ of the first securing member 52′ sits below the helical thread or groove formed on inside surface 35′ of the second component 34′. The use of the first securing members 52′, 52a′ eliminates an uneven sealing surface or drapery effect thus avoiding permeation leakage within the fuel storage tank 10′. A second securing member 54′ having a substantially helical thread or groove formed on an outside surface 56′, a bottom surface 57′ and a top surface 59′ is cooperatively engaged with the substantially helical thread or groove formed on inside surface 35′ of the second component 34′. The bottom surface 57′ of the second securing member 54′ abuts the top surface 55′ of the first securing member 52′ to secure a tight or fixed connection with the first securing member 52′ having a permeation bag 50′ attached thereto and the top surface clearance 37′ of the second component 34′ of the boss 30′, and the second securing member 54′ to the second component 34′ of the boss 30′. The permeation bag 50′ may be in an expanded, enlarged state due to the fuel storage tank 10′ being subjected to high pressure and temperature of the fluid (not shown) within the fuel storage tank 10′, the permeation bag 50 does not adhere to the inner wall 21′ of liner 20′, the permeation bag 50′ expands to shape of inner wall 21′ of the liner 20′. Alternatively, the permeation bag 50′ may be in a retracted, crimped state laying loosely inside the inner cavity 22′ of the liner 20′ due to the fuel storage tank 10′ being subjected to low pressure and temperature of the fluid (not shown) within the fuel storage tank 10′. Similarly, when the fluid inside the fuel storage tank 10′ is subjected to high pressure and temperature the liner 20′ will increase in size to an expanded state. Conversely, when the fluid inside the fuel storage tank 10′ is subjected to low pressure and temperature the liner 20′ will retract in size from the expanded state.

FIG. 2 is an exploded partial cross-sectional view of the boss region 30 of the fuel storage tank 10 of FIG. 1A. FIG. 2 shows the second securing member 54, the first securing member 52 and the boss 30 commonly known as a divided boss having a first component 32 and a second component 34, the reinforcement structure 40 and a portion of the liner 20.

The first securing member 52 has a bottom surface 53, a top surface 55 and a material joint coupling surface 58. The first securing member 52 is capable of affixing a permeation bag 50 (not shown), manufactured outside the fuel storage tank 10, by clamping or welding along the bottom surface 53 and coupling inside the material joint coupling surface 58 of the first securing member 52. Once the permeation bag 50 (not shown) is affixed to the first securing member 52, the permeation bag 50 (not shown) is inserted into the inner cavity 22 through the opening 24 of the liner 20. The bottom surface 53 of the first securing member 52 is capable of adjoining the top surface clearance 37 of the second component 34 such that the top surface 55 of the first securing member 52 sits below the helical thread or groove formed on inside surface 35 of the second component 34. In this manner, the permeation bag 50 (not shown) is squeezed, pressed or clinched inside the material joint coupling surface 58 of the first securing member 52 and simultaneously to the top surface clearance 37 of the second component 34. The use of the first securing member 52 eliminates an uneven sealing surface or drapery effect thus avoiding permeation leakage within the fuel storage tank 10. A second securing member 54 having a substantially helical thread or groove formed on an outside surface 56, a bottom surface 57 and a top surface 59 is cooperatively engaged with the substantially helical thread or groove formed on inside surface 35 of the second component 34 such that the bottom surface 57 of the second securing member 54 abuts the top surface 55 of the first securing member 52 to secure a tight or fixed connection with the first securing member 52 having a permeation bag 50 (not shown) attached thereto to the top surface clearance 37 and the second securing member 54 to the second component 34 of the boss 30.

FIG. 3A illustrates a cross-sectional view of the fuel storage tank 10 of FIG. 1A prior to pressurizing a permeation bag 50 that is disposed therein with a fluid (not shown) to be stored. FIG. 3A shows and describes the fuel storage tank 10 in FIG. 1A such that the permeation bag 50 is shown in a retracted, crimped state laying loosely inside the inner cavity 22 of the liner 20 due to the fuel storage tank 10 being subjected to low pressure and temperature of the fluid (not shown) within the fuel storage tank 10.

In another embodiment (not shown), using reference numerals for similar structures in respect of the description of FIG. 1A are repeated in this further embodiment with a double prime (″) symbol. The fuel storage tank 10″ comprises a liner 20″ defining an inner cavity 22′, at least two bosses 30″, 30a″ having first components 32″, 32a″ and second components 34″, 34a″ connected to an opening 24″, 24a″ formed on each end of the liner 20″, a reinforcement structure 40″ connected around at least a portion of the boss 30″, 30a″ having a first component 32″, 32a″ and a second component 34″, 34a″ and the liner 20″. The permeation bag 50″ is affixed to a first securing member 52″ 52a″, one on each end of the permeation bag 50″, and one end of the permeation bag 50″ is inserted into the inner cavity 22″. The first securing member 52″ is coupled with the second component 34″ of the boss 30″ and the second securing member 54″ is assembled to the second component 34″ of the boss 30″ adjacent the first securing member 52″ to secure a connection between the permeation bag 50″, the liner 20″ and the boss 30″. Secondly, the other or opposite end of the permeation bag 50″ affixed to the first securing member 52a″ is moved to the boss 30″ and the first securing member 52a″ is coupled with the second component 34a″ of the boss 30a″. The second securing member 54a″ is then assembled to the second component 34a″ of the boss 30a″ adjacent the first securing member 52a″ to secure a connection between the permeation bag 50″, the liner 20″ and the boss 30a″ in the same manner described and shown in FIG. 1A. Similar to the embodiment shown and described in FIG. 3A, the permeation bag 50″ is also in a retracted, crimped state due to the fuel storage tank 10″ being subjected to low pressure and temperature of the fluid (not shown) within the fuel storage tank 10″, thus the permeation bag 50″ does not adhere to the walls of liner 20″.

FIG. 3B illustrates a cross-sectional view of the fuel storage tank 10 of FIG. 3A with the permeation bag 50 in a pressurized state. FIG. 3B shows and describes the fuel storage tank 10 in FIG. 3A such that the permeation bag 50 is shown in an expanded, enlarged state due to the fuel storage tank 10 being subjected to high pressure and temperature of the fluid (not shown) within the fuel storage tank 10, the permeation bag 50 does not adhere to the walls of liner 20 just expands to shape of inner walls of the liner 20.

In another embodiment (not shown), using reference numerals for similar structures in respect of the description of FIG. 1A are repeated in this further embodiment with a triple prime (′″) symbol. The fuel storage tank 10′″ comprises a liner 20′″ defining an inner cavity 22′″, at least two bosses 30′″, 30a′″ having first components 32′″, 32a′″ and second components 34′″, 34a′″ connected to an opening 24′″, 24a′″ formed on each end of the liner 20′″, a reinforcement structure 40′″ connected around at least a portion of the boss 30′″ 30a′″ having a first component 32′″, 32a′″ and a second component 34′″, 34a′″ and the liner 20′″. The permeation bag 50′″ is affixed to a first securing member 52′″, 52a′″, one on each end of the permeation bag 50′″, and one end of the permeation bag 50′″ is inserted into the inner cavity 22′″ of the liner 20′″. The first securing member 52′″ is coupled with the second component 34′″ of the boss 30′″ and the second securing member 54′″ is assembled to the second component 34′″ of the boss 30′″ adjacent the first securing member 52′″ to secure a connection between the permeation bag 50′″, the liner 20′″ and the boss 30′″. Secondly, the other or opposite end of the permeation bag 50′″ affixed to the first securing member 52a′″ is moved to the boss 30′″ and the first securing member 52a′″ is coupled with the second component 34a′″ of the boss 30a′″ and the second securing member 54a′″ is assembled to the second component 34a′″ of the boss 30a′″ adjacent the first securing member 52a′″ to secure a connection between the permeation bag 50′″, the liner 20′″ and the boss 30a′″ in the same manner described and shown in FIG. 1A. Similar to the embodiment shown and described in FIG. 3B, the permeation bag 50′″ is also in an expanded, enlarged state due to the fuel storage tank 10′″ being subjected to high pressure and temperature of the fluid (not shown) within the fuel storage tank 10′″, the permeation bag 50′″ does not adhere to the walls of liner 20′″ just expands to shape of inner walls of the liner 20′″.

It is noted that terms like “preferably,” “commonly,” and “typically” are not utilized herein to limit the scope of the claimed disclosure or to imply that certain features are critical, essential, or even important to the structure or function of the claimed disclosure. Rather, these terms are merely intended to highlight alternative or additional features that may or may not be utilized in a particular embodiment of the present disclosure. Likewise, for the purposes of describing and defining the present disclosure, it is noted that the term “device” is utilized herein to represent a combination of components and individual components, regardless of whether the components are combined with other components.

For the purposes of describing and defining the present disclosure it is noted that the term “substantially” is used herein to represent the inherent degree of uncertainty that may be attributed to any quantitative comparison, value, measurement, or other representation. The term “substantially” is used herein also to represent the degree by which a quantitative representation may vary from a stated reference without resulting in a change in the basic function of the subject matter at issue. As such, it is used to represent the inherent degree of uncertainty that may be attributed to any quantitative comparison, value, measurement, or other representation, referring to an arrangement of elements or features that, while in theory would be expected to exhibit exact correspondence or behavior, may in practice embody something slightly less than exact.

Unless otherwise defined, all technical and scientific terms used herein have the same meaning as commonly understood by one of ordinary skill in the art to which the disclosure belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

Having described the disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

What is claimed is:

1. A method of manufacturing a hydrogen storage tank for a fuel cell system, said method comprising:
forming a generally axisymmetric liner to define an inner cavity of said hydrogen storage tank;
connecting at least one boss to an opening formed in at least one end of said liner;
forming a reinforcement structure around at least a portion of said at least one boss and said liner;
affixing a permeation bag to a first securing member;
inserting said permeation bag into said inner cavity;
coupling said first securing member with said at least one boss; and
assembling a second securing member to said at least one boss adjacent said first securing member to secure a connection between said permeation bag, said liner and said at least one boss.

2. The method according to claim 1, wherein said liner defines a single layer liner.

3. The method according to claim 1, wherein said at least one boss comprises a first component and a second component such that said second component is adapted to receive said first securing member and said second securing member.

4. The method according to claim 1, wherein said connecting said reinforcement structure comprises filament winding said reinforcement structure around at least said portion of said at least one boss and said liner.

5. The method according to claim 1, wherein said permeation bag is manufactured using a continuous foil extrusion flat or tubular film process having an inner layer and an outer layer.

6. The method according to claim 5, wherein said inner layer comprises an aluminum composite flat film material having a thickness between about 0.012 to 0.015 mm and an outer layer comprises a high density polyethylene such that the thickness of said inner layer and said outer layer is at least about 0.1 mm.

7. The method according to claim 5, wherein said inner layer comprises an aluminum coated cyclic olefin copolymer tubular film foil material having a thickness between about 0.00005 mm and an outer layer comprises a high density polyethylene or polyethylene such that the thickness of said inner layer and said outer layer between about 0.013 to 0.03 mm.

8. The method according to claim 5, wherein said inner layer comprises silicon monoxide coated with polyethylene terephthalate and polyamide flat film foil material having a thickness between about 0.00004 to 0.00009 mm and an outer layer comprises a sealable polypropylene or polyethylene terephthalate such that the thickness of said inner and said outer layer between about 0.012 to 0.075 mm.

9. The method according to claim 1, wherein said first securing member comprises an O-ring and said second securing member comprises a sleeve including a thread for cooperative engagement with said at least one boss.

10. The method according to claim 1, wherein said first securing member disables rotary movement of said permeation bag while said second securing member is cooperatively attached to said at least one boss.

11. A method of manufacturing a fuel storage tank for a fuel cell system such that a formed portion of said fuel storage tank comprises a single layer liner defining an inner cavity, at least one boss formed in an opening of said liner and a reinforcement structure formed around at least a portion of said at least one boss and said liner, said method comprising:
affixing a permeation bag to a first securing member;
inserting said permeation bag into said inner cavity;
coupling said first securing member with said at least one boss; and
assembling a second securing member to said at least oneboss adjacent said first securing member to secure a connection between said permeation bag and said fuel storage tank.

12. The method according to claim 11, further comprising filling said fuel storage tank with compressed natural gas or hydrogen.

13. The method according to claim 11, wherein said permeation bag is manufactured using a continuous foil extrusion flat or tubular film process having an inner layer and an outer layer.

14. The method according to claim 11, wherein said first securing member comprises an O-ring and said second securing member comprises a sleeve including a thread for assembling to said at least one boss.

15. The method according to claim 11, wherein said first securing member disables rotary movement of said permeation bag while said second securing member is cooperatively attached to said at least one boss.

16. A hydrogen storage tank for a fuel cell system, said hydrogen storage tank comprising:
a generally axisymmetric liner formed to define an inner cavity of said hydrogen storage tank;
at least one boss connected to an opening formed in at least one end of said liner;
a reinforcement structure formed around at least a portion of said at least one boss and said liner;
a permeation bag affixed to a first securing member wherein said permeation bag is inserted into said inner cavity, said first securing member is coupled with said at least one boss and a second securing member is assembled to said at least one boss adjacent said first securing member to secure a connection between said permeation bag, said liner and said at least one boss.

17. The hydrogen storage tank according to claim 16, wherein said liner defines a single layer liner.

18. The hydrogen storage tank according to claim 16, wherein said permeation bag is manufactured using a continuous foil extrusion flat or tubular film process having an inner layer and an outer layer.

19. The hydrogen storage tank according to claim 16, wherein said first securing member comprises an O-ring and said second securing member comprises a sleeve including a thread for cooperative engagement with said at least one boss.

20. The hydrogen storage tank according to claim 16, wherein said first securing member disables rotary movement of said permeation bag while said second securing member is cooperatively attached to said at least one boss.
